(19) United States
(12) Patent Application Publication
(10) Pub. No.: US 2019/0385030 A1
(43) Pub. Date: Dec. 19, 2019

(54) PAGE ANALYSIS METHOD AND APPARATUS

(71) Applicant: BEIJING GRIDSUM TECHNOLOGY CO., LTD., Beijing (CN)

(72) Inventors: Xu GAO, Beijing (CN); Wei SHI, Beijing (CN)

(73) Assignee: BEIJING GRIDSUM TECHNOLOGY CO., LTD., Beijing (CN)

(21) Appl. No.: 16/474,024

(22) PCT Filed: Nov. 28, 2017
(86) PCT No.: PCT/CN2017/113243

§ 371 Date: Jun. 26, 2019

(30) Foreign Application Priority Data
Dec. 30, 2016 (CN) 201611264946.4

(51) Int. Cl. G06K 15/02; G06F 3/03; G06F 16/958; G06F 16/951; G06F 3/0483

(52) U.S. Cl. CPC G06K 15/1856; G06F 3/0312; G06F 3/0308; G06F 3/0483; G06F 16/958; G06F 16/951; G06K 15/1813

(57) ABSTRACT

A page analysis method and device are provided. The method includes: acquiring a display time period of each of page screens of a page and height information of the page screen with respect to the page; and drawing a page screen heat map based on the display time period and the height information of each of the page screens. Information such as interest of the user to different parts of the page may be obtained by acquiring the display time period of each of the page screens of the page, and a page screen heat map indicating a display time period of each of parts of the page with different heights is drawn. Therefore, page browsing information of the user is obtained, and analysis of user behaviors is performed accurately based on the display time period of the page.

This application claims the priority to Chinese Patent Application No. 201611264946.4, titled “PAGE ANALYSIS METHOD AND APPARATUS”, filed on Dec. 30, 2016 with the Chinese Patent Office, which is incorporated herein by reference in its entirety.

### FIELD

The present disclosure relates to the technical field of data processing, and in particular to a page analysis method and device.

### BACKGROUND

With the rapid development of the Internet technology, people increasingly rely on networks in their daily lives, and more and more people prefer to browse webpages for information acquisition or information processing. In this case, information about a user may be acquired by collecting and analyzing operations of the user on the webpage, thus behaviors of the users may be obtained by the analysis based on the information.

Currently, interests of users to a webpage are determined via a common Web Analytics tool from a click heat map. That is, behaviors of the user are obtained by analyzing operations such as clicks on the webpage by the user via a mouse.

However, in a case of browsing a webpage including only texts, a large proportion of texts or a small proportion of clickable regions, the user may remain at the webpage for a long time period without any click since the user is interested in some content on the webpage and spends a long time period on it. In this case, since the user performs no click on the webpage during the long time period, it is impossible to determine the behavior of the user such as the interest to the content on the page and core concern point on the page just from the current click heat map.

### SUMMARY

A page analysis method and device are provided according to the embodiments of the present disclosure, to perform an analysis on user behaviors accurately based on display time periods of a page.

The following technical solution is provided according to an embodiment of the present disclosure, to solve the above technical problems.

A page analysis method is provided, which includes:

acquiring a display time period of each of page screens of a page and height information of the page screen with respect to the page, where the page screen represents a part of the page displayed in a screen window in a case that the page is not scrolled; and

drawing a page screen heat map based on the display time period and the height information of each of the page screens, where the page screen heat map indicates a display time period of each of parts of the page with different heights.

The following technical solution is provided according to an embodiment of the present disclosure, to solve the above technical problems.

A page analysis device is provided, which includes an acquiring unit and a drawing unit. The acquiring unit is configured to acquire a display time period of each of page screens of a page and height information of the page screen with respect to the page. The page screen represents a part of the page displayed in a screen window in a case that the page is not scrolled. The drawing unit is configured to draw a page screen heat map based on the display time period and the height information of each of the page screens. The page screen heat map indicates a display time period of each of parts of the page with different heights.

It can be seen from the above technical solutions, the following advantages are achieved according to the embodiments of the present disclosure. The display time period of each of the page screens of the page and the height information of the page screen with respect to the page are acquired, and the page screen heat map is drawn based on the display time period and the height information of each of the page screens. A page screen is generated in the screen window in a case that the user browses the page. The page screen represents a part of the page displayed in the screen window in a case that the page is not scrolled. The display time period of the page screen indicates a time period spent by the user for browsing the page screen, that is, a time period spent by the user for browsing a part of the page at the page screen. Information such as interest of the user to different parts of the page may be obtained by acquiring the display time period of each of the page screens of the page, and a page screen heat map is drawn based on the display time period and the height information of each of the page screens of the page. The page screen heat map indicates a display time period of each of parts of the page with different heights. In this way, page browsing information of the user is obtained, and analysis of user behaviors may be performed accurately based on the display time period of the page.

### BRIEF DESCRIPTION OF THE DRAWINGS

FIG. 1 is a diagram showing a scenario to which a page analysis method according to an embodiment of the present disclosure is applied;

FIG. 2 is a diagram showing a scenario to which a page analysis method according to an embodiment of the present disclosure is applied;

FIG. 3 is a flowchart of a page analysis method according to an embodiment of the present disclosure;

FIG. 4 is a flowchart of a page analysis method according to an embodiment of the present disclosure;

FIG. 5 a diagram showing a relationship among heights according to the embodiment shown in FIG. 4; and

FIG. 6 is a schematic structural diagram of a page analysis device according to an embodiment of the present disclosure.

### DETAILED DESCRIPTION OF EMBODIMENTS

A page analysis method and device are provided according to the embodiments of the present disclosure, to perform analysis on user behaviors accurately based on the display time periods of the page.

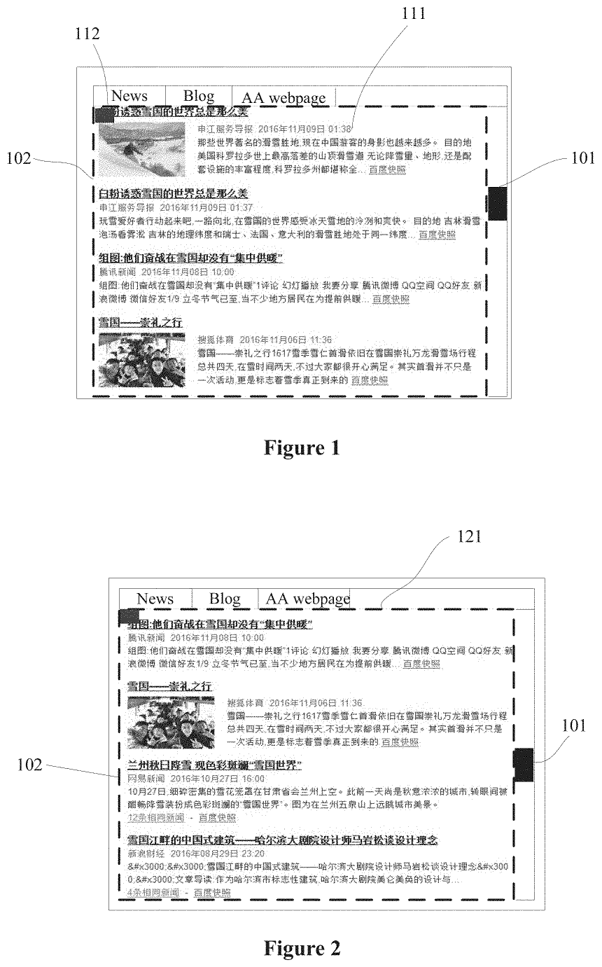

FIGS. 1 and 2 are diagrams respectively showing a scenario to which the page analysis method according to the embodiment of the present disclosure is applied. As shown in FIGS. 1 and 2, a page screen of a page is displayed in a screen window. The page screen indicates a part of the page displayed in the screen window in a case that the page is not scrolled.

The page may be a webpage or the like. Contents of the page are displayed to the user via the screen window.

The screen window is used to display the contents of the page. The screen window may be, for example, a part for displaying content on the webpage in a browser window. The screen window may be arranged on a device operated by the user, for example, a computer.

The page may be scrolled across the screen window under control of the user via a mouse wheel, a window scrollbar 101 or the like. For example, in a case that the user browses the page shown in FIG. 1, a first page screen 111 is displayed in the screen window 102, and the first page screen belongs to a target webpage. The page is scrolled downward under the control of the use via the mouse wheel, such that the first page screen is moved away from the screen window. When the user stops rolling the mouse wheel, a second page screen 121 is displayed in the screen window, and the second page screen also belongs to the target webpage.

In the embodiment of the present disclosure, the webpage to be monitored may be deployed with codes, such that detection on operations of the user such as scrolling the page (e.g. the webpage) and acquisition of the display time period of the page screen and height information of the page screen with respect to the page may both be performed through the codes.

For example, each time the user rolls the mouse wheel, data is transmitted to a data collecting server via the codes (Tracker) deployed on the webpage to be monitored. The data is embodied as one log record in the data collecting server. Each log record indicates one mouse wheel rolling operation of the user. A data analysis server acquires a log file from the data collecting server. The tracker includes a short segment of JavaScript codes and is configured to collect data of user behaviors and system information at the webpage side and transmit the data to the data collecting server.

In the embodiment of the present disclosure, it is required to acquire the display time period of each of the page screens of the page and height information of the page screen with respect to the page, to perform analysis of user behaviors. For example, as shown in FIG. 1, in a case that the user browses the first page screen, the first page screen is displayed in the screen window for a time period until the first page screen is scrolled away from the screen window, where the time period represents the display time period of the first page screen.

The height information of a page screen with respect to the page indicates a height of the page screen in the whole page, that is, a height of the part displayed in the screen window in the whole page. The whole page includes the part of the page displayed in the screen window and parts of the page beyond the screen window. Different page screens have different heights in the page. A height direction indicates a direction in which the page is scrolled. As shown in FIGS. 1 and 2, the page is scrolled up and down across the screen window, and the up and down direction indicates the height direction in the screen window.

In an embodiment of the present disclosure, it is required to acquire height of a screen point of each of page screens in the page, to obtain height information of the page screen with respect to the page, which is described in the following embodiment. The screen point may represent the page screen. The relationship between the screen point and the page screen is similar to the relationship between an object and its centroid. A position of the screen point on the page is preset, which is not limited herein.

For example, as shown in FIG. 1, the first page screen includes a first screen point 112. Height of the first screen point in the page is related to a display height of the screen window, and the height information of the first page screen with respect to the page is acquired.

The page screen heat map may be drawn based on the display time period and the height information of each of the page screens, and the page screen heat map indicates the display time period of each of parts of the page with different heights. A page screen is generated in the screen window in a case that the user browses the page. The page screen represents a part of the page displayed in the screen window in a case that the page is not scrolled. The display time period of the page screen represents a time period spent by the user for browsing the page screen, that is, a time period spent by the user for browsing a part of the page corresponds to the page screen. Information such as interest of the user to different parts of the page may be obtained by acquiring the display time period of each of the page screens of the page, and a page screen heat map may be drawn based on the display time period and the height information of each of the page screens of the page. The page screen heat map indicates the display time period of each of parts of the page with different heights, such that page browsing information of the user is acquired, thus analysis on user behaviors is performed accurately based on the display time period of the page.

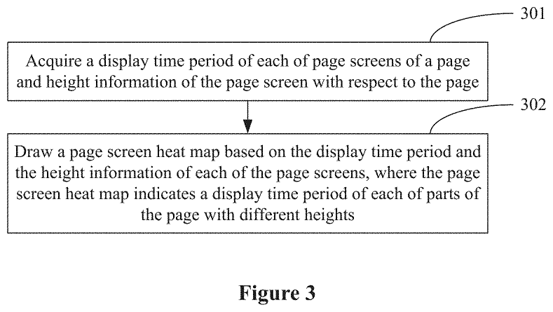

FIG. 3 is a flowchart of a page analysis method according to an embodiment of the present disclosure. With reference to the above scenarios and description, as shown in FIG. 3, the method according to the embodiment of the present disclosure includes the following steps 301 to 302.

In step 301, a display time period of each of page screens of a page and height information of the page screen with respect to the page are acquired. The page screen represents a part of the page displayed in the screen window in a case that the page is not scrolled.

In step 302, a page screen heat map is drawn based on the display time period and the height information of each of the page screens. The page screen heat map indicates a display time period of each of parts of the page with different heights.

In an embodiment, the acquiring the display time period of each of the page screens of the page and the height information of the page screen with respect to the page includes: acquiring, when it is detected that a mouse wheel is rolled, a display time period of a target page screen and height information of the target page screen with respect to the page are acquired until the mouse wheel is rolled. The page is scrolled across the screen window under control via the mouse wheel, and the target page screen represents any one of the page screens.

In an embodiment, the acquiring, when it is detected that the mouse wheel is rolled, the display time period of the target page screen until the mouse wheel is rolled includes: starting timing when it is detected that the mouse wheel is stopped rolling; and stopping timing when it is detected that the mouse wheel is rolled, to acquire the display time period of the target page screen.

In an embodiment, the acquiring the display time period of each of the page screens of the page and the height information of the page screen with respect to the page includes: acquiring, for each of statistic users, the display time period of each of the page screens of the page and the height information of the page screen with respect to the page in a case that the statistic user browses the page.

The drawing the page screen heat map based on the display time period and the height information of each of the page screens includes: counting the display time period and the height information of each of the page screens of the page acquired for each of the statistic users in a case that the statistic user browses the page, to determine a display time period of each of height pixel points in the page, where the height pixel point indicates a pixel point in the page in a height direction; and drawing the page screen heat map based on the display time period of each of the height pixel points.

In an embodiment, the drawing the page screen heat map based on the display time period of each of the height pixel points includes: ranking the height pixel points based on the display time period of each of the height pixel points, to obtain a ranking result; assigning each of the height pixel points one color based on the ranking result; and drawing the page screen heat map on the page based on the color assigned to each of the height pixel points.

In an embodiment, the acquiring the height information of each of the page screens with respect to the page includes: acquiring a display height of the screen window; acquiring an overall height of the page and a height of a screen point of each of the page screens in the page, where the screen point is a point preset in the page screen and represents the page screen; and determining height information of each of the page screens with respect to the page based on the height of the screen point of the page screen, the overall height of the page and the display height of the screen window.

In an embodiment, the method further includes: determining, among all the statistic users, the number of target users scrolling the page to display a target height pixel point in the screen window; and determining a proportion of the number of the target users to the number of all the statistic users.

In summary, the display time period of each of the page screens of the page and the height information of the page screen with respect to the page are acquired, and the page screen heat map is drawn based on the display time period and the height information of each of the page screens. A page screen is generated in the screen window in a case that the user browses the page. The page screen represents a part of the page displayed in the screen window in a case that the page is not scrolled. The display time period of the page screen indicates a time period spent by the user for browsing the page screen, that is, a time period spent by the user for browsing a part of the page corresponds to the page screen. Information such as interest of the user to different parts of the page may be obtained by acquiring the display time period of each of the page screens of the page, and a page screen heat map is drawn based on the display time period and the height information of each of the page screens of the page. The page screen heat map indicates a display time period of each of parts of the page with different heights. In this way, page browsing information of the user is obtained, thus analysis of user behaviors is performed accurately based on the display time period of the page.

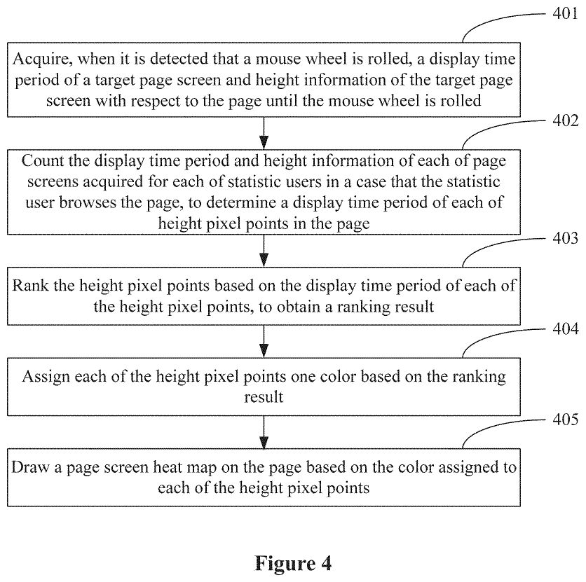

FIG. 4 is a flowchart of a page analysis method according to an embodiment of the present disclosure. With reference to the scenarios shown in FIGS. 1 and 2 and the above description, as shown in FIG. 4, the method according to the embodiment of the present disclosure includes the following steps 401 to 405.

In step 401, when it is detected that a mouse wheel is rolled, a display time period of a target page screen and height information of the target page screen with respect to the page are acquired until the mouse wheel is rolled.

The page is scrolled across the screen window under control via mouse wheel, that is, the page is scrolled across the screen window under the control of the user via the mouse wheel.

The page screen represents the part of the page displayed in the screen window in a case that the page is not scrolled. The target page screen may represent any one of page screens of the page, that is, each of the page screens of the page may be used as the target page screen.

A page screen of the page is displayed in a screen window. The user controls the page via a mouse connected to a device for which the screen window is provided. For example, the page is scrolled across the screen window under the control of the user via a mouse wheel. When it is detected that the mouse wheel is rolled, the target page screen displayed in the screen window is to be scrolled away from the screen window before the mouse wheel is rolled, for another page screen of the page to be displayed in the screen window. The page is scrolled under the control of the user via the mouse wheel, when the mouse wheel is stopped rolling, another page screen of the page is displayed in the screen window. In this way, the display time period of the target page screen and height information of the target page screen with respect to the page are acquired until the mouse wheel is rolled in time. Since the target page screen is scrolled away from the screen window in a case that the mouse wheel is rolled, the display time period of the target page screen is acquired more accurately when it is detected that the mouse wheel is rolled.

Each time it is detected that the mouse wheel is rolled, the display time period of the target page screen and height information of the target page screen with respect to the page are acquired until the mouse wheel is rolled. The page screen is changed from one to another under the control via the mouse wheel, that is, each of page screens of the page is controlled to be displayed in the screen window via rolling the mouse wheel. In this way, the display time period of each of the page screens of the page and height information of the page screen with respect to the page are acquired in step 401.

It is to be understood that, the step 401 is only one way to acquire the display time period of each of page screens of the page and height information of the page screen with respect to the page, which is not limited in the embodiment of the present disclosure.

In an embodiment of the present disclosure, it may be acquired, when it is detected that a scrollbar of the screen window is dragged, the display time period of the target page screen and height information of the target page screen with respect to the page until the scrollbar is dragged. The page is scrolled across the screen window under the control of the user by dragging the scrollbar displayed in the screen window, the part of the page displayed in the screen window when the user stops dragging the scrollbar is called a current page screen.

In an embodiment of the present disclosure, it may be triggered the acquiring the display time period of the target page screen and height information of the target page screen with respect to the page in response to a detection of a stroking by the user on the screen. The screen is a touchscreen. Each time the user stops stroking on the touchscreen, the part of the page displayed in the screen window is called the current page screen.

It should be understood that, in an embodiment of the present disclosure, the above multiple trigger mechanisms may be used together. That is, the acquiring the display time period of the target page screen and height information of the target page screen with respect to the page may be triggered in response to the detection of the rolling of the mouse wheel, the dragging of the scrollbar of the window, or the stroking on the screen by the user.

It is to be understood that the order of acquiring the display time period of the target page screen and acquiring height information of the target page screen with respect to the page is not limited to the embodiment of the present disclosure.

The method according to the embodiment of the present disclosure may be applied by a page analysis device. The page analysis device may be in communication with a user device, or some units of the page analysis device are arranged on the user device. The screen window is arranged in the user device. The user or statistic user browses content on the page via the user device.

In the embodiment shown in FIG. 4, the process of acquiring the display time period of the target page screen may be achieved by triggering timing via rolling the mouse wheel. For example, the acquiring, when it is detected that the mouse wheel is rolled, the display time period of the target page screen until the mouse wheel is rolled includes: starting timing when it is detected that the mouse wheel is stopped rolling, where the target page screen is displayed in the screen window at this time; and stopping timing when it is detected that the mouse wheel is rolled, to acquire the display time period of the target page screen.

When it is detected that the mouse wheel is stopped rolling, the target page screen is displayed in the screen window, and the timing may be started for calculating the display time period of the target page screen. When it is detected that the mouse wheel is rolled, the target page screen is to be scrolled away from the screen window, to display another page screen of the page, the timing may be stopped. In this way, the display time period of the target page screen is acquired by the above timing operation.

In addition, there are other ways to acquire the display time period of the target page screen. For example, when it is detected that the mouse wheel is stopped rolling, the target page screen is displayed in the screen window, and a first time is acquired. Further, when it is detected that the mouse wheel is rolled, the target page screen is to be scrolled away from the screen window, a second time is acquired. The display time period of the target page screen may be calculated based on the first time and the second time.

In an embodiment shown in FIG. 4, there are many ways to acquire height information of the target page screen with respect to the page. For example, in an embodiment, the acquiring height information of each of target page screens with respect to the page includes the following steps A1 to A3.

In step A1, a display height of the screen window is acquired. The display height of the screen window indicates a height of the content of the page displayed in the screen window.

In step A2, an overall height of the page and height information of a screen point of each of the page screens with respect to the page are acquired. The screen point is a point preset in the page screen and represents the page screen. The description to the screen point may be referred to the scenarios shown in FIGS. 1 and 2.

In step A3, height information of each of the page screens with respect to the page is determined based on the height of the screen point of the page screen, the overall height of the page and the display height of the screen window.

The display height of the screen window is the same as a displayed height of a page screen, and the screen point represents the page screen. The relationship between the screen point and the page screen is similar to the relationship between an object and its centroid. A position of the page screen relative to the page may be described using a position of the screen point of the page screen relative to the page.

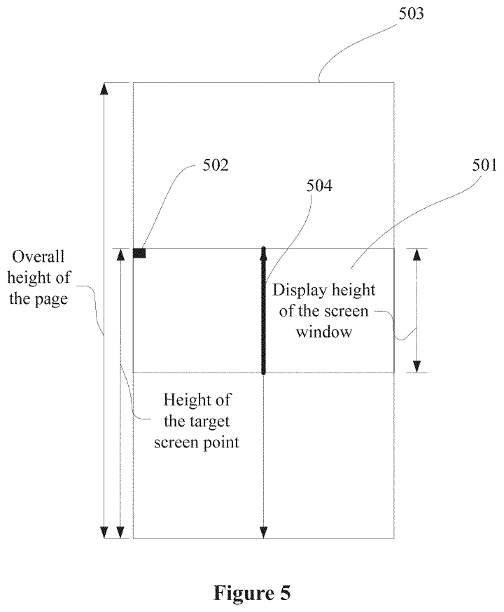

Reference is made to FIG. 5, which is a diagram showing a relationship among heights according to an embodiment of the present disclosure. A target screen point 502 is arranged on the target page screen 501 and represents the target page screen. In a case that the height of the target screen point in the page 503 is determined, an actual displayed height of the target page screen is obtained based on height information of the target screen point and the display height of the screen window. Further, the height information of the target page screen with respect to the page is obtained combined with the overall height of the page. Height information 504 of the target page screen indicates not only the height of the target page screen in the page, but also a proportion of the displayed height of the target page screen to the overall height of the page. In this way, even though devices of users vary in sizes and resolutions of screen window, height information of each of the page screens with respect to the page can be accurately acquired using the method according to the embodiment of the present disclosure. Therefore, the method for acquiring height information of the page screen is applicable to a scenario of acquiring information of multiple users. In the embodiment of the present disclosure, a start point of the height is not limited, which may be located at the bottom or the beginning of the page.

In the embodiment of the present disclosure, analysis may be performed on behaviors of one user based on the display time periods of the page. However, in order to acquire more useful data, the data of multiple users is acquired using the method according to the embodiment of the present disclosure, such that analysis may be performed on behaviors of multiple users to obtain data macroscopically indicating popular behaviors. The multiple users from whom the data is collected are called statistic users in the embodiment of the present disclosure.

Therefore, in order to acquire statistically significant data, in the embodiment shown in FIG. 4, the acquiring the display time period of each of the page screens of the page and height information of the page screen with respect to the page includes: acquiring, for each of the statistic users, the display time period of each of the page screens of the page and height information of the page screen with respect to the page in a case that the statistic user browses the page. That is, step 401 is performed for each of the statistic users in a case that the statistic user browses the page. That is, in a case that each of the statistic users browses the page to be monitored, the operation of rolling mouse wheels by each of the statistic users may be detected, and display time period and height information of each of the page screens generated in a case that each of the statistic users browses the page may be acquired for data analysis.

In step 402, the display time period and the height information of each of the page screens of the page acquired for each of the statistic users in a case that the statistic user browses the page are counted, to determine a display time period of each of height pixel points in the page.

The height pixel point indicates a pixel point of the page in a height direction. Different pixel points have different heights in the page, and positions of the pixel points in a width direction of the page are not limited in the embodiment of the present disclosure. A display time period of the height pixel point indicates an overall display time period of the height pixel point spent by all the statistic users to browse the page. A display time period of each height pixel point is initially set to be 0.

A page screen heat map may be drawn for a user based on the acquired display time periods and height information of page screens generated by the user in a case that the user browses the page. Further, in a case of acquiring, for each of the statistic users, display time period and height information of each of page screens generated in a case that the statistic user browses the page, it is required to combine display time periods and height information of page screens generated in a case that each of the statistic users browses the page in a height pixel point basis. Since users may browse the page using different devices which have screen windows of different sizes or different pixels, it is difficult to perform analysis effectively by simply adding the display time periods and height information of the page screens generated in a case that the users browse the page. In order to solve this problem, in the embodiment of the present disclosure, data is combined in a height pixel point basis. That is, the page screen heat map is displayed on a device for drawing the page screen heat map through pixel points. In the present disclosure, the display time periods of parts of the page in a height direction are shown, pixel points in the height direction are focused in the embodiment of the present disclosure when displaying the page screen heat map. Since the page screen heat map is drawn on the page and the page screen heat map corresponds to the display time periods of the parts of the page in the height direction, the height pixel point indicates a pixel point of the page in a height direction according to the embodiment of the present disclosure.

Based on the display time period and height information of each of the page screens generated in a case that the user browses the page, a display time period of each of the height pixel points is determined, the display time period is a time period spent by the user to browse the page on the device. The display time period corresponds to the height pixel point on the device displaying the page screen heat map, that is, the display time period does not depend on the browsing condition at the user device. In this way, the display time period and height information of each of page screens generated by multiple users are acquired, this information of page screens of the multiple users respectively correspond to the height pixel points, data from different users are combined in a height pixel point basis.

In step 403, the height pixel points are ranked based on the display time period of each of the height pixel points, to obtain a ranking result.

After the display time period of each of the height pixel points is determined, the height pixel points are ranked based on the display time period of each of the height pixel points, to obtain a ranking result indicating the ranking information of the height pixel points.

In step 404, each of the height pixel points is assigned one color based on the ranking result.

The height pixel points with different display time periods may be assigned with different colors respectively. In the method according to the embodiment of the present disclosure, a color set is provided, which includes multiple colors, such as red, yellow, blue and green. Colors in the color set are ranked in advance, and each of the height pixel points is assigned one color having a ranked position corresponding to that of the height pixel point based on the ranking result of the height pixel points and the ranking information of the colors.

For example, if a display time period of a height pixel point is ranked within the top twenty percent among display time periods of all the height pixel points, the height pixel point is assigned a color of the color set preset at the top twenty percent in the ranking information.

In step 405, the page screen heat map is drawn on the page based on the color assigned to each of the height pixel points.

The page screen heat map indicates a display time period of each of parts of the page with different heights.

In a case that the height pixel point of the page to be displayed is assigned the color, the color is displayed at the position of the height pixel point, such that the page screen heat map is drawn. Since parts of the page with different height may display different colors, which generate information, the page screen heat map indicates the display time period of each of parts of the page with different heights.

For example, the colors for assigning, that is, the colors of the page screen heat map may include red, orange, yellow, blue, green, achromatic color and the like. The display time periods of the height pixel points are respectively presented by different colors. For example, a warm color such as red, orange and yellow represents a long display time period, which indicates that the user browses the part of the page for a long time period. In addition, a cold color such as green, blue and white indicates that the display time period of the height pixel point with this color is short, which indicates that the user browses the part of the page for a short time period.

It should be understood that, the above steps 403 to 406 only show one way to draw the page screen heat map based on the display time period of each of the height pixel points according to the embodiment of the present disclosure. In an embodiment, the page screen heat map may be drawn by another way. For example, a correspondence between display time periods and colors are preset, and each of the height pixel points is assigned one color corresponding to the display time period of the height pixel point based on the correspondence. In this way, the height pixel point may display the assigned color, such that the page screen heat map is drawn based on the colors of the height pixel points.

In an embodiment of the present disclosure, since the page screen heat map indicates display time period of each of parts of the page with different heights, information of the page screen heat map in the width direction is not limited herein. For example, the width of the page screen heat map is preset. In order to achieve a better visual effect on the page, it is required to acquire the overall height and width of the page to be displayed, to make the page screen heat map cover the page. For example, before drawing the page screen heat map based on the display time period and height information of each of the page screens, the method according to the embodiment of the present disclosure further includes: acquiring the height and width of the page to be covered by the heat map. In this case, the drawing the page screen heat map based on the display time period and height information of each of the page screens includes: determining a drawing region for the page screen heat map on the page based on the height and width of the page; and drawing the page screen heat map in the drawing region based on the display time period and height information of each of the page screens.

The drawing region is determined based on the overall height and width of the page, that is, the drawing region may indicate the overall height and width of the page. For example, the drawing region covers the page, such that the page screen heat map covers the page in a case that the page screen heat map is drawn in the drawing region.

Further, in an embodiment, since a set of the height pixel points may indicate the height of the page, it is unnecessary to acquire the height of the page.

With the method according to the embodiment of the present disclosure, by monitoring the information of the page screens, it may be determined that which page screen is of interest to the users, which page screen takes a long time period of the users, or on which page screens a higher conversion rate is generated, so as to further optimize the page.

In an embodiment of the present disclosure, a page analysis method is further provided, which includes: determining, among all the statistic users, the number of target users scrolling the page to display a target height pixel point in the screen window; and determining a proportion of the number of the target users to the number of all the statistic users. In this way, a heat map indicating a proportion of the number of the target users to the number of all the statistic users may be redrawn, or each of the height pixel points on the page for analysis is marked with a numerical number, so as to show the proportion to an analytical user.

For example, taking one accessing behavior of each of the users to each monitored page as a unit, a proportion of the users browsing a region at a height pixel point of the page to all the statistic users is calculated. For example, one hundred percent of the users scroll the page to a height pixel point of the page and browse the region at the height pixel point by rolling the mouse wheel, and eighty percent of the users scroll the page to another height pixel point of the page and browse a region at the other height pixel point by rolling the mouse wheel.

In summary, the display time period of each of the page screens of the page and the height information of the page screen with respect to the page are acquired, and the page screen heat map is drawn based on the display time period and the height information of each of the page screens. A page screen is generated in the screen window in a case that the user browses the page. The page screen represents a part of the page displayed in the screen window in a case that the page is not scrolled. The display time period of the page screen indicates a time period spent by the user for browsing the page screen, that is, a time period spent by the user for browsing a part of the page at the page screen. Information such as interest of the user to different parts of the page may be obtained by acquiring the display time period of each of the page screens of the page, and a page screen heat map is drawn based on the display time period and the height information of each of the page screens of the page. The page screen heat map indicates a display time period of each of parts of the page with different heights. In this way, page browsing information of the user is obtained, thus analysis is performed accurately on user behaviors based on the display time period of the page.

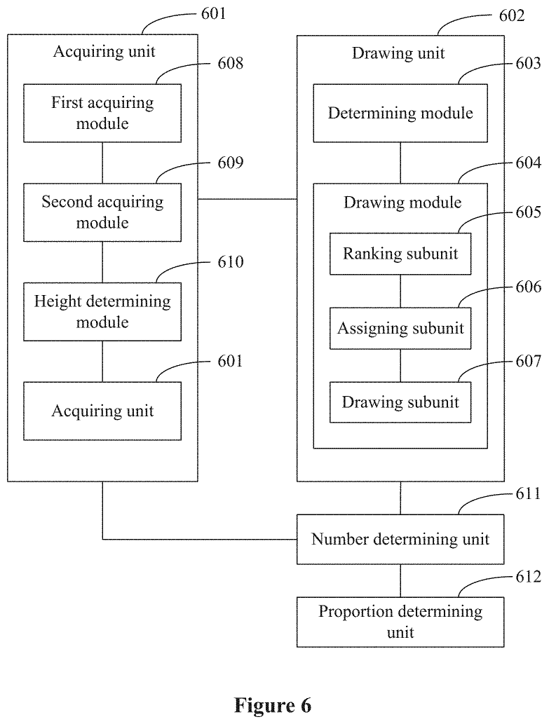

FIG. 6 is a schematic structural diagram of a page analysis device according to an embodiment of the present disclosure. With reference to the above description, as shown in FIG. 6, the device according to the embodiment of the present disclosure includes an acquiring unit 601 and a drawing unit 602. The acquiring unit 601 is configured to acquire a display time period of each of page screens of a page and height information of the page screen with respect to the page. The page screen represents a part of the page displayed in a screen window in a case that the page is not scrolled. The drawing unit 602 is configured to draw a page screen heat map based on the display time period and the height information of the page screen. The page screen heat map indicates display time periods of the page at different heights.

In an embodiment, the acquiring unit 601 is further configured to acquire, when it is detected that a mouse wheel is rolled, a display time period of a target page screen and height information of the target page screen with respect to the page until the mouse wheel is rolled. The page is scrolled across the screen window under control via the mouse wheel, and the target page screen represents any one of the page screens.

In an embodiment, the acquiring unit 601 is further configured to: start timing when it is detected that the mouse wheel is stopped rolling; and stop timing when it is detected that the mouse wheel is rolled, to obtain the display time period of the target page screen.

In an embodiment, the acquiring unit 601 is further configured to acquire, for each of statistic users, the display time period of each of the page screens of the page and the height information of the page screen with respect to the page in a case that the statistic user browses the page.

The drawing unit 602 includes a determining module 603 and a drawing module 604. The determining module 603 is configured to count the display time period and the height information of each of the page screens of the page acquired for each of the statistic users in a case that the statistic user browses the page, to determine a display time period of each of height pixel points in the page. The height pixel point indicates a pixel point in the page in a height direction. The drawing module 604 is configured to draw the page screen heat map based on the display time period of each of the height pixel points.

In an embodiment, the drawing module 604 includes a ranking subunit 605, a distributing subunit 606 and a drawing subunit 607. The ranking subunit 605 is configured to rank the height pixel points based on the display time period of each of the height pixel points, to obtain a ranking result. The distributing subunit 606 is configured to assign each of the height pixel points one color based on the ranking result. The drawing subunit 607 is configured to draw the page screen heat map on the page based on the color assigned to each of the height pixel points.

In an embodiment, the acquiring unit 601 includes a first acquiring module 608, a second acquiring module 609 and a height determining module 610. The first acquiring module 608 is configured to acquire a display height of the screen window. The second acquiring module 609 is configured to acquire an overall height of the page and a height of a screen point of each of the page screens in the page. The screen point is preset in the page screen and represents the page screen. The height determining module 610 is configured to determine height information of each of the page screens with respect to the page based on the height of the screen point of the page screen, the overall height of the page and the display height of the screen window.

In an embodiment, the device further includes a number determining unit 611 and a proportion determining unit 612. The number determining unit 611 is configured to determine, among all the statistic users, the number of target users scrolling the page to display a target height pixel point in the screen window. The proportion determining unit 612 is configured to determine a proportion of the number of the target users to the number of all the statistic users.

In summary, the acquiring unit 601 acquires the display time period of each of the page screens of the page and the height information of the page screen with respect to the page, the drawing unit 602 draws the page screen heat map based on the display time period and the height information of each of the page screens. A page screen is generated in the screen window in a case that the user browses the page. The page screen represents a part of the page displayed in the screen window in a case that the page is not scrolled. The display time period of the page screen indicates a time period spent by the user for browsing the page screen, that is, a time period spent by the user for browsing a part of the page at the page screen. Information such as interest of the user to different parts of the page may be obtained by acquiring the display time period of each of the page screens of the page, and a page screen heat map is drawn based on the display time period and the height information of each of the page screens of the page. The page screen heat map indicates a display time period of each of parts of the page with different heights. In this way, page browsing information of the user is obtained, thus analysis on user behaviors is performed accurately based on the display time period of the page.

It is to be clearly understood by those skilled in the art that, in order to describe embodiments of the present disclosure conveniently and clearly, for detailed operating processes of the system, device and unit, reference may be made to the description to that in the above embodiments of the method, which is not repeated herein.

In the embodiments of the present disclosure, it should be understood that the system, device and method described herein may be implemented in other ways. The device embodiments described above are illustrative only. For example, the units are divided merely in logical function, which may be divided by another way in actual implementation. For example, multiple units or components may be combined or integrated into another system, or some features may be ignored or not performed. In addition, coupling among shown or discussed parts which may be direct coupling or communication connection can be via some interfaces, and the direct coupling or communication connection among devices or units can be electrical, mechanical or other forms.

The above unit described as a separate component may be or may be not separated physically. The component displayed as a unit may be or may be not a physical unit, that is, may be located at one place or may be distributed on multiple network units. The object of the solution of the embodiment may be achieved by selecting a part or all of the units according to the actual requirements.

Furthermore, functional units in embodiments of the present disclosure may be separate physical units respectively or integrated into one processing unit. Alternatively, two or more units may be integrated into one unit. The integrated unit may be implemented in a form of hardware, or may be implemented in a form of a software functional unit.

In a case that the integrated unit is implemented in the form of a software functional units and functions as an independent product for sale or use, it may also be stored in a computer readable storage medium. Based on such understandings, the technical solutions or part of the technical solutions disclosed in the present disclosure that makes contributions to the conventional technology or part of the technical solutions may be essentially embodied in the form of a software product. The software product may be stored in a storage medium. The software product includes a number of instructions that allow a computer device (a PC, a server, or a network device) to execute all or part of the steps of the methods provided in the embodiments of the present disclosure. The above storage medium include various mediums capable of storing program code, for example, a U disk, a mobile hard disk, a read only memory (ROM), random access memory (RAM), magnetic disk, or compact disc-read only memory (CD-ROM).

The above embodiments are only intended for describing the technical solutions of the present application, and should not be interpreted as limitation to the present disclosure. Although the present disclosure is described in detail with references to the embodiments above described, as those skilled in the art understand, the technical solutions embodied in the above embodiments can be modified, or some technical features can be substituted with the equivalents. Such modifications or substitutions do not depart the nature of corresponding technical solutions from the spirit and scope of the technical solutions embodied in the embodiments according to the present disclosure.

1. A page analysis method, comprising:
acquiring a display time period of each of page screens of a page and height information of the page screen with respect to the page, wherein the page screen represents a part of the page displayed in a screen window in a case that the page is not scrolled; and
drawing a page screen heat map based on the display time period and the height information of each of the page screens, wherein the page screen heat map indicates a display time period of each of parts of the page with different heights.

2. The method according to claim 1, wherein the acquiring the display time period of each of page screens of the page and the height information of the page screen with respect to the page comprises:
acquiring, when it is detected that a mouse wheel is rolled, a display time period of a target page screen and height information of the target page screen with respect to the page until the mouse wheel is rolled, wherein the page is scrolled across the screen window under a control via the mouse wheel, and the target page screen represents any one of the page screens.

3. The method according to claim 2, wherein the acquiring, when it is detected that the mouse wheel is rolled, the display time period of the target page screen until the mouse wheel is rolled comprises:
starting timing when it is detected that the mouse wheel is stopped rolling; and
stopping timing when it is detected that the mouse wheel is rolled, to obtain the display time period of the target page screen.

4. The method according to claim 1, wherein
the acquiring the display time period of each of page screens of the page and the height information of the page screen with respect to the page comprises:
acquiring, for each of statistic users, the display time period of each of page screens of the page and the height information of the page screen with respect to the page in a case that the statistic user browses the page,
the drawing the page screen heat map based on the display time period and the height information of each of the page screens comprises:
counting, for each of the statistic users, the display time period and the height information of each of the page screens of the page in a case that the statistic user browses the page, to determine a display time period of each of height pixel points in the page, wherein the height pixel point indicates a pixel point in the page in a height direction; and
drawing the page screen heat map based on the display time period of each of the height pixel points.

5. The method according to claim 4, wherein the drawing the page screen heat map based on the display time period of each of the height pixel points comprises:
ranking the height pixel points based on the display time period of each of the height pixel points, to obtain a ranking result;
assigning, based on the ranking result, each of the height pixel points one color; and
drawing, based on the color assigned to each of the height pixel points, the page screen heat map on the page.

6. The method according to claim 1, wherein the acquiring the height information of each of the page screens with respect to the page comprises:
acquiring a display height of the screen window;
acquiring an overall height of the page and a height of a screen point of each of the page screens in the page, wherein the screen point is preset on the page screen and represents the page screen; and
determining height information of each of the page screens with respect to the page based on the height of the screen point of the page screen, the overall height of the page and the display height of the screen window.

7. The method according to claim 1, further comprising:
determining, among all the statistic users, the number of target users scrolling the page to display a target height pixel point in the screen window; and
determining a proportion of the number of the target users to the number of all the statistic users.

8. A page analysis device, comprising:
an acquiring unit configured to acquire a display time period of each of page screens of a page and height information of the page screen with respect to the page, wherein the page screen represents a part of the page displayed in a screen window in a case that the page is not scrolled; and
a drawing unit configured to draw a page screen heat map based on the display time period and the height information of each of the page screens, wherein the page screen heat map indicates a display time period of each of parts of the page with different heights.

9. The device according to claim 8, wherein the acquiring unit is further configured to acquire, when it is detected that a mouse wheel is rolled, a display time period of a target page screen and height information of the target page screen with respect to the page until the mouse wheel is rolled, wherein the page is scrolled across the screen window under a control of the mouse wheel, and the target page screen represents any one of the page screens.

10. The device according to claim 9, wherein the acquiring unit is further configured to:
start timing when it is detected that the mouse wheel is stopped rolling; and
stop timing when it is detected that the mouse wheel is rolled, to obtain the display time period of the target page screen.

11. The method according to claim 2, wherein the acquiring the height information of each of the page screens with respect to the page comprises:
acquiring a display height of the screen window;
acquiring an overall height of the page and a height of a screen point of each of the page screens in the page, wherein the screen point is preset on the page screen and represents the page screen; and
determining height information of each of the page screens with respect to the page based on the height of the screen point of the page screen, the overall height of the page and the display height of the screen window.

12. The method according to claim 3, wherein the acquiring the height information of each of the page screens with respect to the page comprises:
acquiring a display height of the screen window;
acquiring an overall height of the page and a height of a screen point of each of the page screens in the page, wherein the screen point is preset on the page screen and represents the page screen; and
determining height information of each of the page screens with respect to the page based on the height of the screen point of the page screen, the overall height of the page and the display height of the screen window.

13. The method according to claim 4, wherein the acquiring the height information of each of the page screens with respect to the page comprises:
acquiring a display height of the screen window;
acquiring an overall height of the page and a height of a screen point of each of the page screens in the page, wherein the screen point is preset on the page screen and represents the page screen; and
determining height information of each of the page screens with respect to the page based on the height of the screen point of the page screen, the overall height of the page and the display height of the screen window.

14. The method according to claim 5, wherein the acquiring the height information of each of the page screens with respect to the page comprises:
acquiring a display height of the screen window;
acquiring an overall height of the page and a height of a screen point of each of the page screens in the page, wherein the screen point is preset on the page screen and represents the page screen; and
determining height information of each of the page screens with respect to the page based on the height of the screen point of the page screen, the overall height of the page and the display height of the screen window.

15. The method according to claim 2, further comprising:
determining, among all the statistic users, the number of target users scrolling the page to display a target height pixel point in the screen window; and
determining a proportion of the number of the target users to the number of all the statistic users.

16. The method according to claim 3, further comprising:
determining, among all the statistic users, the number of target users scrolling the page to display a target height pixel point in the screen window; and
determining a proportion of the number of the target users to the number of all the statistic users.

17. The method according to claim 4, further comprising:
determining, among all the statistic users, the number of target users scrolling the page to display a target height pixel point in the screen window; and
determining a proportion of the number of the target users to the number of all the statistic users.

18. The method according to claim 5, further comprising:
determining, among all the statistic users, the number of target users scrolling the page to display a target height pixel point in the screen window; and
determining a proportion of the number of the target users to the number of all the statistic users.

19. A computer-readable storage medium having stored thereon a program code, the program code comprising instructions for carrying out the method according to claim 1, when executed on a computer.
